(19) United States
(12) Patent Application Publication
(10) Pub. No.: US 2017/0142797 A1
(43) Pub. Date: May 18, 2017

(54) CONTROL CIRCUIT FOR LED AND ACTIVE BLEEDER THEREOF

(71) Applicants: CHEN-HUA CHIU, NEW TAIPEI CITY (TW); MOON-HO CHOI, SEOUL (KR); GWAN-BON KOO, GYEONGGI-DO (KR)

(72) Inventors: CHEN-HUA CHIU, NEW TAIPEI CITY (TW); MOON-HO CHOI, SEOUL (KR); GWAN-BON KOO, GYEONGGI-DO (KR)

(21) Appl. No.: 15/347,987

(22) Filed: Nov. 10, 2016

Related U.S. Application Data
(60) Provisional application No. 62/254,251, filed on Nov. 12, 2015.

(51) Int. Cl. H05B 33/08

(52) U.S. Cl. CPC H05B 33/0845; H05B 33/083; H05B 33/0815

(57) ABSTRACT

A control circuit for LED and an active bleeder thereof are provided. The control circuit comprises an LED driver and the active bleeder. The LED driver drives at least one LED and generates a current-sense signal. The current-sense signal is correlated to an LED current. The active bleeder comprises a bleeder circuit. The bleeder circuit is coupled to the LED driver to receive the current-sense signal and sinks a bleeding current in accordance with the current-sense signal for keeping the current flowing through the dimmer higher than the holding current.

### REFERENCE TO RELATED APPLICATIONS

This Patent Application is a Utility Application of Provisional Application No. 62/254,251, filed 12 Nov. 2015, currently pending.

### BACKGROUND OF THE INVENTION

Field of Invention

The present invention relates to LED, and more specifically relates to a control circuit for LED and an active bleeder.

Description of the Related Art

The LED (Light-Emitting Diode) lamps are widely used in a variety of electronic applications due to LED lamps have significant advantages, such as long life time, small size, and high efficiency. In general, the LED system comprises a dimmer, such as TRIAC dimmer, which is used to adjust the brightness of the LED lamps. The TRIAC dimmer is triggered every half of AC cycle. While it is trigged, the current flowing through it should be kept higher than a threshold current for the remaining half AC cycle. The threshold current is called holding current. Thus, the present invention provides a control circuit for LED and an active bleeder for sinking a bleeding current in order to keep the current flowing through the dimmer higher than the holding current.

### BRIEF SUMMARY OF THE INVENTION

The objective of the present invention is to provide a control circuit for LED and an active bleeder for sinking a bleeding current according to a current-sense signal correlated to an LED current, that may be used to keep the current flowing through the dimmer higher than the holding current.

A control circuit for LED according to the present invention comprises an LED driver and a bleeder circuit. The LED driver drives at least one LED and generates a current-sense signal. The current-sense signal is correlated to an LED current. The bleeder circuit is coupled to the LED driver to receive the current-sense signal and sinks a bleeding current in accordance with the current-sense signal.

An active bleeder according to the present invention comprises a bleeder circuit. The bleeder circuit is coupled to the LED driver to receive a current-sense signal and sinks a bleeding current in accordance with the current-sense signal. The current-sense signal is correlated to an LED current.

### BRIEF DESCRIPTION OF THE DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 is a circuit diagram of an embodiment of the LED system in accordance with the present invention.

FIG. 2 is a circuit diagram of the first embodiment of the control circuit in accordance with the present invention.

FIG. 3 is a circuit diagram of the second embodiment of the control circuit in accordance with the present invention.

FIG. 4 is a circuit diagram of the third embodiment of the control circuit in accordance with the present invention.

FIG. 5 is a circuit diagram of another embodiment of the LED system in accordance with the present invention.

### DETAILED DESCRIPTION OF EMBODIMENTS

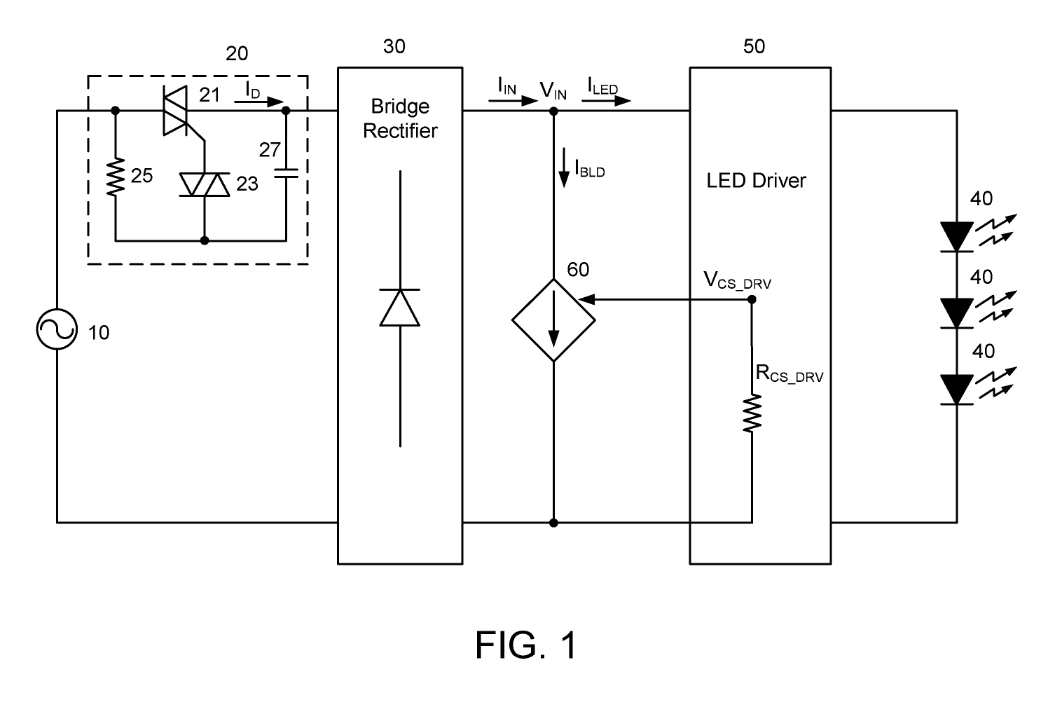

FIG. 1 is a circuit diagram of an embodiment of the LED system in accordance with the present invention. As shown in FIG. 1, the LED system comprises an AC power source 10, a dimmer 20, a bridge rectifier 30, a plurality of LEDs 40, and a control circuit. The control circuit comprises an LED driver 50 and an active bleeder including a bleeder circuit 60. The dimmer 20 is coupled between the AC power source 10 and the bridge rectifier 30. The AC power source 10 supplies the AC power to the bridge rectifier 30 through the dimmer 20. The dimmer 20 may be a TRIAC dimmer according to one embodiment of the present invention.

The dimmer 20 comprises a tri-electrode AC switch (for example TRIAC switch 21), a Di-electrode AC switch (for example DIAC switch 23), a resistor 25, and a capacitor 27. The first terminal of the TRIAC switch 21 is coupled to the AC power source 10. The second terminal of the TRIAC switch 21 is coupled to the bridge rectifier 30. The first terminal of the DIAC switch 23 is coupled to the control terminal of the TRIAC switch 21. The first terminal of the resistor 25 is coupled to the AC power source 10 and the first terminal of the TRIAC switch 21. The second terminal of the resistor 25 is coupled to the second terminal of the DIAC switch 23 and the second terminal of the capacitor 27. The first terminal of the capacitor 27 is coupled to the second terminal of the TRIAC switch 21 and the bridge rectifier 30.

The bridge rectifier 30 rectifies the AC power for providing an input power which supplies an input voltage V_{IN} and an input current I_{IN}. The input current I_{IN} provides an LED current I_{LED} for driving the LEDs 40. The LED driver 50 is coupled to the LEDs 40 to drive the LEDs 40. The LED driver 50 comprises a current-sense element R_{CS}_{_}_{DRV} which is coupled to the LED current I_{LED} for sensing the LED current I_{LED} and generating a current-sense signal V_{CS}_{_}_{DRV}. The bleeder circuit 60 is coupled to the LED driver 50 to receive the current-sense signal V_{CS}_{_}_{DRV}, and sinks a bleeding current I_{BLD} from the input current I_{IN} in accordance with the current-sense signal V_{CS}_{_}_{DRV}. That is, the bleeder circuit 60 sinks the bleeding current I_{BLD} from the input power provided by the bridge rectifier 30. Thus, the bleeder circuit 60 sinks the bleeding current I_{BLD} form the AC power source 10 for increasing a current I_{D} flowing through the dimmer 20 in order to keep the current I_{D} higher than the holding current for maintaining the dimmer 20 in conduction state.

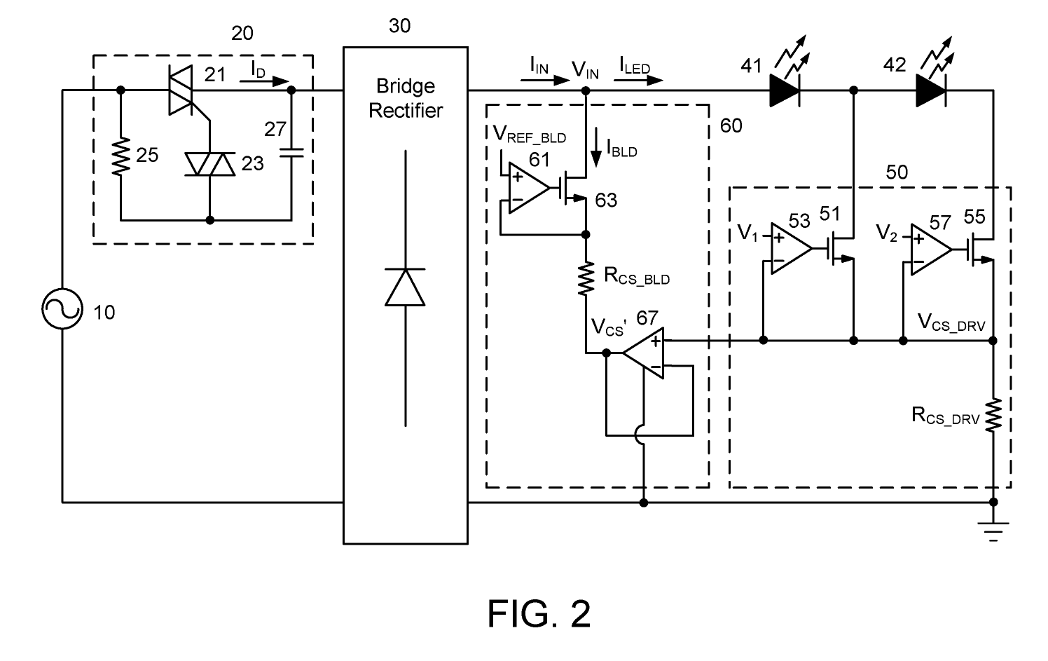

FIG. 2 is a circuit diagram of the first embodiment of the control circuit in accordance with the present invention. As shown in FIG. 2, the LED driver 50 comprises a plurality of driving units and the current-sense element R_{CS DRV}. Each of the driving units comprises a transistor and an operational amplifier. The driving units are operated as the current regulators. According to this embodiment, the LED driver 50 comprises a first driving unit and a second driving unit corresponding to two LEDs 41 and 42, respectively. The LEDs 41 and 42 are coupled to each other in series.

The first driving unit comprises a first transistor 51 and a first operational amplifier 53. The second driving unit comprises a second transistor 55 and a second operational amplifier 57. The first transistor 51 is coupled between the cathode of the first LED 41 and the ground. The second transistor 55 is coupled between the cathode of the second LED 42 and the ground. The first terminal of the current-sense element R_{CS}_{_}_{DRV} is coupled to the second terminals (source terminals) of the first transistor 51 and the second transistor 55. The second terminal of the current-sense element R_{CS}_{_}_{DRV} is coupled to the ground. The current-sense element R_{CS}_{_}_{DRV} is utilized to sense the LED current I_{LED} flowing through the LEDs 41, 42 and generate the current-sense signal V_{CS}_{_}_{DRV}. Therefore, the current-sense signal V_{CS}_{_}_{DRV} represents the LED current I_{LED}.

The negative input terminals of the operational amplifiers 53 and 57 are coupled to the first terminal of the current-sense element R_{CS}_{_}_{DRV} to receive the current-sense signal V_{CS}_{_}_{DRV}. A first reference signal V₁ is supplied to the positive input terminal of the first operational amplifier 53. The output terminal of the first operational amplifier 53 is coupled to the gate terminal of the first transistor 51. The first operational amplifier 53 controls the first transistor 51 to regulate the LED current I_{LED} for driving the first LED 41 in response to the current-sense signal V_{CS}_{_}_{DRV} and the first reference signal V₁. A second reference signal V₂ is supplied to the positive input terminal of the second operational amplifier 57. The output terminal of the second operational amplifier 57 is coupled to the gate terminal of the second transistor 55. The second operational amplifier 57 controls the second transistor 55 to regulate the LED current I_{LED} for driving the LEDs 41 and 42 in response to the current-sense signal V_{CS}_{_}_{DRV} and the second reference signal V₂. The LED current I_{LED} is determined by the first reference signal V₁, the second reference signal V₂, and the current-sense element R_{CS}_{_}_{DRV}.

Once the input voltage V_{IN} is higher than the forward voltage of the first LED 41 and lower than the summation of the forward voltages of the LEDs 41 and 42, the first LED 41 is driven and the LED current I_{LED} flows through the first LED 41, the first transistor 51 and the current-sense element R_{CS}_{_}_{DRV}. The second LED 42 is not driven, and therefore the LED current I_{LED} doesn't flow through the second LED 42. The LED current I_{LED} can be expressed as:

$${I}_{LED} = \frac{{V}_{1}}{{R}_{CS\_DRV}} \qquad ( 1 )$$

Once the input voltage V_{IN} is higher than the summation of the forward voltages of the LEDs 41 and 42, the LEDs 41 and 42 are driven and the LED current I_{LED} flows through the LEDs 41, 42, the second transistor 55, and the current-sense element R_{CS}_{_}_{DRV}. The LED current I_{LED} can be expressed as:

$${I}_{LED} = \frac{{V}_{2}}{{R}_{CS\_DRV}} \qquad ( 2 )$$

The first driving unit (including the first transistor 51 and the first operational amplifier 53) and the second driving unit (including the second transistor 55 and the second operational amplifier 57) are operated as the current regulators for regulating the LED current I_{LED}. The second reference signal V₂ is higher than the first reference signal V₁, and therefore the first current regulator (upstream current regulator) is disabled when the second current regulator (downstream current regulator) regulates the LED current I_{LED}.

The bleeder circuit 60 comprises a current sink circuit and a buffer 67. The current sink circuit may be implemented by the voltage-to-current convertor according to one embodiment of the present invention. The voltage-to-current convertor comprises an operational amplifier 61, a transistor 63, and a resistor R_{CS BLD}. The first terminal (drain terminal) of the transistor 63 is coupled to the output terminal of the bridge rectifier 30 to receive the input power, and the second terminal (source terminal) of the transistor 63 is coupled to the negative input terminal of the operational amplifier 61 and the first terminal of the resistor R_{CS}_{_}_{BLD}. A bleeding reference signal V_{REF}_{_}_{BLD} is supplied to the positive input terminal of the operational amplifier 61. The output terminal of the operational amplifier 61 is coupled to the gate terminal of the transistor 63. The second terminal of the resistor R_{CS}_{_}_{BLD} is coupled to the output terminal of the buffer 67. The positive input terminal of the buffer 67 is coupled to the current-sense element R_{CS}_{_}_{DRV} of the LED driver 50 to receive the current-sense signal V_{CS}_{_}_{DRV}. The negative input terminal of the buffer 67 is coupled to the output terminal of the buffer 67. The buffer 67 is further coupled to the ground. The buffer 67 is used for buffering the current-sense signal V_{CS}_{_}_{DRV} and generating a buffering signal V_{CS}′. The buffer 67 is an unity gain buffer according to one embodiment of the present invention.

The current sink circuit of the bleeder circuit 60 is coupled to the input power and the output (buffering signal V_{CS}′) of the buffer 67 for sinking the bleeding current I_{BLD} from the input power in accordance with the current-sense signal V_{CS}_{_}_{DRV} and the bleeding reference signal V_{REF}_{_}_{BLD}. The bleeding current I_{BLD} can be expressed as:

$${I}_{BLD} = \frac{{V}_{REF\_BLD} - {V}_{CS}^{′}}{{R}_{CS\_BLD}} = \frac{{V}_{REF\_BLD} - {I}_{LED} \times {R}_{CS\_DRV}}{{R}_{CS\_BLD}} \qquad ( 3 )$$

According to the equation (3), the bleeding current I_{BLD} is adjusted according to the current-sense signal V_{CS}_{_}_{DRV} due to the buffering signal V_{CS}′ is correlated to the current-sense signal V_{CS}_{_}_{DRV}. When the LED current I_{LED} is lower, the buffering signal V_{CS}′ is also lower. Therefore, the bleeding current I_{BLD} will be increased to keep the current I_{D} flowing through the dimmer 20 higher than the holding current. When the LED current I_{LED} becomes higher, the bleeding current I_{BLD} will be decreased. Once the LED current I_{LED} is higher than the holding current, the bleeding current I_{BLD} may be decreased to zero. Accordingly, the bleeder circuit 60 acts as a current regulator, and the LED current I_{LED} doesn't flow through the bleeder circuit 60.

Once the resistance value of the current-sense element R_{CS}_{_}_{DRV} is equal to the resistance value of the resistor R_{CS}_{_}_{BLD} and the amplitude value of the LED current I_{LED} is lower than the amplitude value of the bleeding reference signal V_{REF}_{_}_{BLD} divided by the resistance value of the resistor R_{CS}_{_}_{BLD}, the input current I_{IN} can be expressed as:

$${{I}_{IN} \vert}_{{R}_{CS\_DRV} = {R}_{CS\_BLD} , {I}_{LED} < \frac{{V}_{REF\_BLD}}{{R}_{CS\_BLD}}} = \frac{{V}_{REF\_BLD}}{{R}_{CS\_BLD}} \qquad ( 4 )$$

According to equation (4), the bleeding current I_{BLD} keeps the input current I_{IN} higher than the holding current. That is, the current I_{D} flowing through the dimmer 20 is kept higher than the holding current.

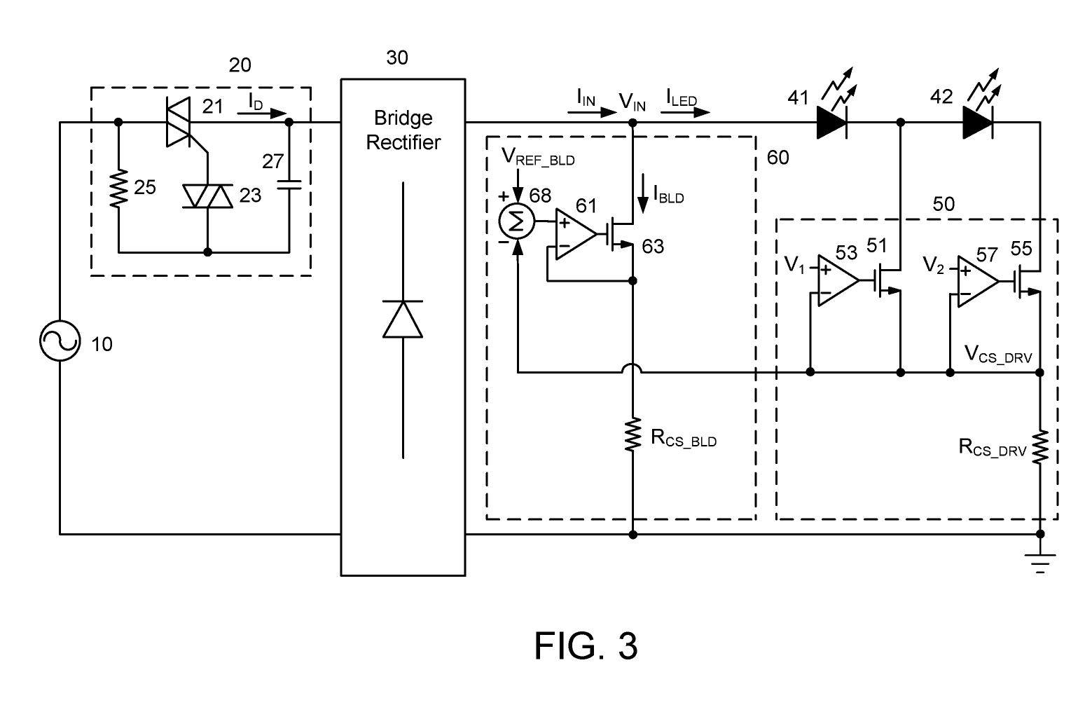

FIG. 3 is a circuit diagram of the second embodiment of the control circuit in accordance with the present invention. As shown in FIG. 3, the bleeder circuit 60 of this embodiment doesn't require the buffer 67 (as shown in FIG. 2). The bleeder circuit 60 comprises the voltage-to-current convertor (the current sink circuit) and an operation unit 68. The voltage-to-current convertor comprises the operational amplifier 61, the transistor 63, and the resistor R_{CS}_{_}_{BLD}.

The first terminal of the resistor R_{CS}_{_}_{BLD} is coupled to the negative input terminal of the operational amplifier 61 and the second terminal (source terminal) of the transistor 63. The second terminal of the resistor R_{CS}_{_}_{BLD} is coupled to the ground. The operation unit 68 is coupled to the current-sense element R_{CS}_{_}_{DRV} of the LED driver 50 to receive the current-sense signal V_{CS}_{_}_{DRV}. The bleeding reference signal V_{REF}_{_}_{BLD} is supplied to the operation unit 68. The operation unit 68 generates an output signal in response to the current-sense signal V_{CS}_{_}_{DRV} and the bleeding reference signal V_{REF}_{_}_{BLD}. The operation unit 68 generates the output signal by subtracting the level of the current-sense signal V_{CS}_{_}_{DRV} from the level of the bleeding reference signal V_{REF}_{_}_{BLD}. The operation unit 68 serves as a subtractor. The output terminal of the operation unit 68 is coupled to the positive input terminal of the operational amplifier 61, and therefore the output signal of the operation unit 68 is supplied to the positive input terminal of the operational amplifier 61. Accordingly, the current sink circuit of this embodiment sinks the bleeding current I_{BLD} from the input power in accordance with the output signal of the operation unit 68.

The bleeding current I_{BLD} can be expressed as:

$${I}_{BLD} = \frac{{V}_{REF\_BLD} - {V}_{CS\_DRV}}{{R}_{CS\_BLD}} = \frac{{V}_{REF\_BLD} - {I}_{LED} \times {R}_{CS\_DRV}}{{R}_{CS\_BLD}} \qquad ( 5 )$$

According to the equation (5), the bleeding current I_{BLD} is adjusted according to the current-sense signal V_{CS}_{_}_{DRV}. When the LED current I_{LED} is lower, the current-sense signal V_{CS}_{_}_{DRV} is also lower, and therefore the output signal (V_{REF}_{_}_{BLD}−V_{CS}_{_}_{DRV}) is increased, that the bleeding current I_{BLD} will be increased to keep the current I_{D} flowing through the dimmer 20 higher than the holding current. When the LED current I_{LED} becomes higher, the output signal (V_{REF}_{_}_{BLD}−V_{CS}_{_}_{DRV}) is decreased. Therefore, the bleeding current I_{BLD} will be decreased.

Once the resistance value of the current-sense element R_{CS}_{_}_{DRV} is equal to the resistance value of the resistor R_{CS}_{_}_{BLD} and the amplitude value of the LED current I_{LED} is lower than the amplitude value of the bleeding reference signal V_{REF}_{_}_{BLD} divided by the resistance value of the resistor R_{CS}_{_}_{BLD}, the input current I_{IN} can be expressed as:

$${{I}_{IN} \vert}_{{R}_{CS\_DRV} = {R}_{CS\_BLD} , {I}_{LED} < \frac{{V}_{REF\_BLD}}{{R}_{CS\_BLD}}} = \frac{{V}_{REF\_BLD}}{{R}_{CS\_BLD}} \qquad ( 6 )$$

According to equation (6), the bleeding current I_{BLD} keeps the input current I_{IN} higher than the holding current. That is, the current I_{D} is kept higher than the holding current.

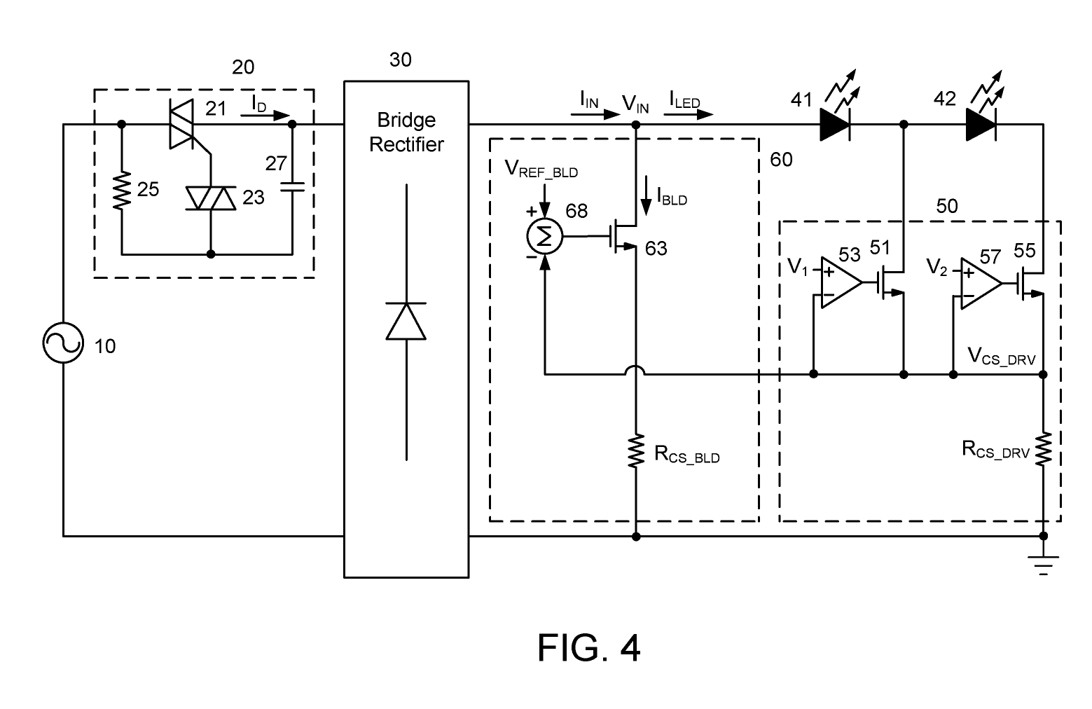

FIG. 4 is a circuit diagram of the third embodiment of the control circuit in accordance with the present invention. As shown in FIG. 4, the bleeder circuit 60 of this embodiment doesn't require the operational amplifier 61 (as shown in FIG. 3). The bleeder circuit 60 of this embodiment comprises the transistor 63, the operation unit 68, and the resistor R_{CS}_{_}_{BLD}. The operation unit 68 generates the output signal in response to the current-sense signal V_{CS}_{_}_{DRV} and the bleeding reference signal V_{REF}_{_}_{BLD}. The operation unit 68 serves as a subtractor. The output terminal of the operation unit 68 is coupled to the gate terminal of the transistor 63, and therefore the output signal of the operation unit 68 is coupled to the gate terminal of the transistor 63 to control the transistor 63.

The bleeding current I_{BLD} is regulated by characteristic of the transistor 63. When the source voltage of the transistor 63 is lower than the gate voltage minus the threshold voltage, the transistor 63 will be turned on. When the source voltage of the transistor 63 is higher than the gate voltage minus the threshold voltage, the transistor 63 will be turned off. Therefore, the bleeding current I_{BLD} will be regulated. The bleeding current I_{BLD} can be expressed as:

$${I}_{BLD} = \frac{{V}_{G} - {V}_{TH}}{{R}_{CS\_BLD}} \qquad ( 7 )$$

The V_{G} represents the gate voltage of the transistor 63, and the V_{TH} represents the threshold voltage of the transistor 63. The amplitude of the output signal of the operation unit 68 is the gate voltage of the transistor 63. Therefore, the transistor 63 is controlled by the output signal of the operation unit 68 for sinking the bleeding current I_{BLD} from the input power in accordance with the output signal. The gate voltage of the transistor 63 is controlled by the amplitude of the bleeding reference signal V_{REF}_{_}_{BLD} and the amplitude of the current-sense signal V_{CS}_{_}_{DRV}. The bleeding current I_{BLD} will be increased when the LED current I_{LED} is lower.

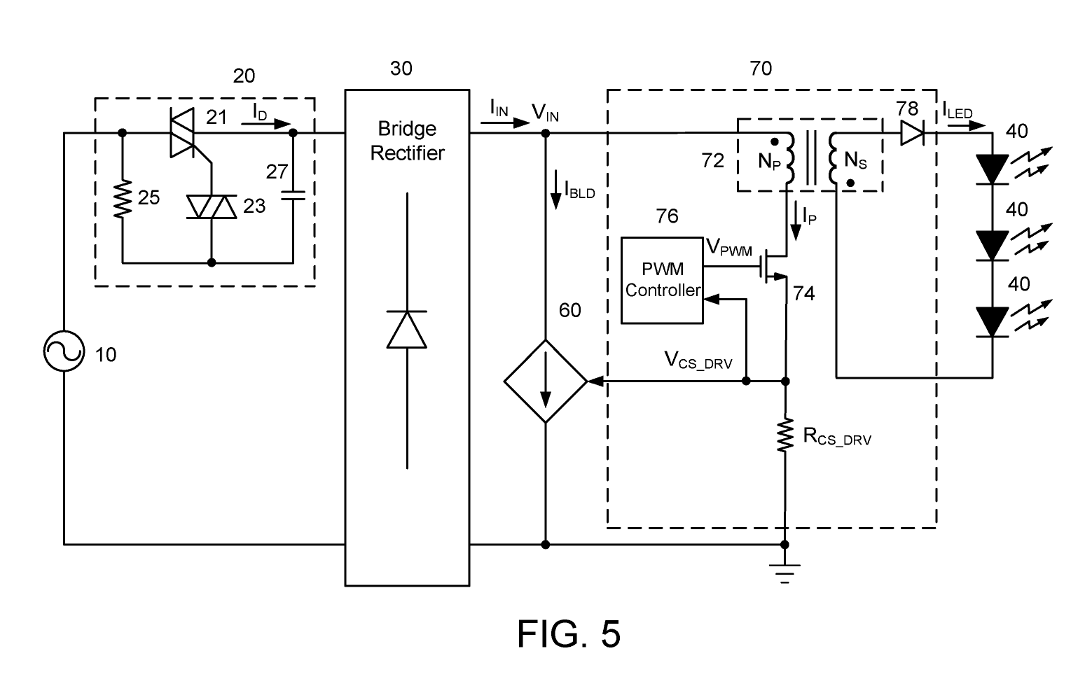

FIG. 5 is a circuit diagram of another embodiment of the LED system in accordance with the present invention. In embodiments shown in FIGS. 2-4, the LED drivers are progressive forward-biased linear LED drivers, however the LED driver of the present invention is not limited to that application. The LED driver can be a switching regulator.

As shown in FIG. 5, the LED driver 70 comprises a transformer 72, a power switch 74, a PWM (Pulse Width Modulation) controller 76, and the current-sense element R_{CS}_{_}_{DRV}. The transformer 70 includes a primary winding N_{P} and a secondary winding N_{S}. The secondary winding N_{S} generates the LED current I_{LED} via a rectifier 78. The first terminal of the rectifier 78 is coupled to the first terminal of the secondary winding N_{S}. The LEDs 40 is coupled between the second terminal of the rectifier 78 and the second terminal of the secondary winding N_{S}.

The first terminal of the primary winding N_{P} is coupled to the output terminal of the bridge rectifier 30 to receive the input voltage V_{IN}. The first terminal of the power switch 74 is coupled to the second terminal of the primary winding N_{P}. The current-sense element R_{CS}_{_}_{DRV} is coupled between the second terminal of the power switch 74 and the ground for generating the current-sense signal V_{CS}_{_}_{DRV}. The PWM controller 76 is coupled to the first terminal of the current-sense element R_{CS}_{_}_{DRV} to receive the current-sense signal V_{CS}_{_}_{DRV}. The PWM controller 76 generates a switching signal V_{PWM} in response to the current-sense signal V_{CS}_{_}_{DRV} to switch the power switch 74 for regulating the LED current I_{LED}. When the power switch 74 is turned on, a switching current I_{P} flows through the power switch 74. The switching current I_{P} is proportional to the LED current I_{LED}. The current-sense element R_{CS}_{_}_{DRV} is used to sense the witching current I_{P} for generating the current-sense signal V_{CS}_{_}_{DRV}. That is, the current-sense element R_{CS}_{_}_{DRV} is used to sense the LED current I_{LED}, and the current-sense signal V_{CS}_{_}_{DRV} is correlated to the LED current I_{LED}.

The bleeder circuit 60 is coupled to the current-sense element R_{CS}_{_}_{DRV} to receive the current-sense signal V_{CS}_{_}_{DRV} for sinking the bleeding current I_{BLD} in accordance with the current-sense signal V_{CS}_{_}_{DRV}, that is used to keep the current I_{D} flowing through the dimmer 20 higher than the holding current for keeping the dimmer 20 in conduction state.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A control circuit for LED, comprising:
an LED driver, driving at least one LED, and generating a current-sense signal correlated to an LED current; and
a bleeder circuit, coupled to the LED driver to receive the current-sense signal, and sinking a bleeding current in accordance with the current-sense signal.

2. The control circuit as claimed in claim 1, wherein the bleeder circuit sinks the bleeding current form a power source for increasing a current flowing through a dimmer.

3. The control circuit as claimed in claim 1, wherein the bleeding current is increased when the LED current flowing through the LED is decreased.

4. The control circuit as claimed in claim 1, wherein the bleeder circuit comprises:
a buffer, coupled to the LED driver to receive the current-sense signal; and
a current sink circuit, coupled to an input power and an output of the buffer for sinking the bleeding current from the input power in accordance with the current-sense signal and a bleeding reference signal.

5. The control circuit as claimed in claim 1, wherein the bleeder circuit comprises:
an operation unit, coupled to the LED driver to receive the current-sense signal, and generating an output signal in response to the current-sense signal and a bleeding reference signal; and
a current sink circuit, coupled to an input power and an output of the operation unit for sinking the bleeding current from the input power in accordance with the output signal of the operation unit.

6. The control circuit as claimed in claim 1, wherein the bleeder circuit comprises:
an operation unit, coupled to the LED driver to receive the current-sense signal, and generating an output signal in response to the current-sense signal and a bleeding reference signal; and
a transistor, coupled to an input power and controlled by the output signal of the operation unit for sinking the bleeding current from the input power in accordance with the output signal.

7. The control circuit as claimed in claim 1, wherein the LED driver comprises at least one driving unit, and each driving unit comprises:
a transistor, coupled between the LED and a ground; and
an operational amplifier, controlling the transistor for driving the LED in response to a reference signal.

8. The control circuit as claimed in claim 1, wherein the LED driver comprises a current-sense element sensing the LED current for generating the current-sense signal.

9. An active bleeder, comprising:
a bleeder circuit, coupled to an LED driver to receive a current-sense signal, and sinking a bleeding current in accordance with the current-sense signal, wherein the current-sense signal is correlated to an LED current.

10. The active bleeder as claimed in claim 9, wherein the bleeder circuit sinks the bleeding current form a power source for increasing a current flowing through a dimmer.

11. The active bleeder as claimed in claim 9, wherein the bleeding current is increased when the LED current flowing through the LED is decreased.

12. The active bleeder as claimed in claim 9, wherein the bleeder circuit comprises:
a buffer, coupled to the LED driver to receive the current-sense signal; and
a current sink circuit, coupled to an input power and an output of the buffer for sinking the bleeding current from the input power in accordance with the current-sense signal and a bleeding reference signal.

13. The active bleeder as claimed in claim 9, wherein the bleeder circuit comprises:
an operation unit, coupled to the LED driver to receive the current-sense signal, and generating an output signal in response to the current-sense signal and a bleeding reference signal; and
a current sink circuit, coupled to an input power and an output of the operation unit for sinking the bleeding current from the input power in accordance with the output signal of the operation unit.

14. The active bleeder as claimed in claim 9, wherein the bleeder circuit comprises:
an operation unit, coupled to the LED driver to receive the current-sense signal, and generating an output signal in response to the current-sense signal and a bleeding reference signal; and
a transistor, coupled to an input power and controlled by the output signal of the operation unit for sinking the bleeding current from the input power in accordance with the output signal.

15. The active bleeder as claimed in claim 9, wherein the LED driver comprises at least one driving unit, and each driving unit comprises:
a transistor, coupled between an LED and a ground; and
an operational amplifier, controlling the transistor for driving the LED in response to a reference signal.

16. The active bleeder as claimed in claim 9, wherein the LED driver comprises a current-sense element sensing the LED current for generating the current-sense signal.
